(19) United States
(12) Patent Application Publication
(10) Pub. No.: US 2005/0007247 A1
(43) Pub. Date: Jan. 13, 2005

(54) Multi-detection apparatus

(76) Inventor: Eric Kao, Taoyuan Hsien (TW)

Correspondence Address: BIRCH STEWART KOLASCH & BIRCH, PO BOX 747, FALLS CHURCH, VA, 22040-0747, US

(21) Appl. No.: 10/615,837

(22) Filed: Jul. 10, 2003

(51) Int. Cl. G08B 29/00

(52) U.S. Cl. 340/506

(57) ABSTRACT

A single housing multi-detection apparatus installed at a surveillance location to activate different devices at different time. This multi-detection apparatus includes at least one control circuit board to receive signals output from at least two detection units at different time and activate different devices at different time to achieve multiple detection and surveillance functions.

### FIELD OF THE INVENTION

The present invention relates to a single housing multi-detection apparatus and particularly to an apparatus for detecting the same target at different time and place to activate different receiving devices to achieve multiple detection and surveillance functions.

### BACKGROUND OF THE INVENTION

Nowadays many residences, companies and parking lots have installed burglar alarm apparatus on the entrances, exits, doors and windows to fend off intruders or thefts. Some have installed or contracted security systems to protect the safety of houses, companies and parking lots.

While the security systems can provide thorough security measures all year around under the full time surveillance of security people, they usually are more expensive. In general only large office buildings, communities, and banks can afford such services. Ordinary people or households mostly cannot afford such services. Hence some residences have purchased and installed through outside experts unmanned burglar alarm apparatus in the house, parking lots (garage) and outdoors to do surveillance without people. The detection devices used in those burglar alarm apparatus generally are infrared sensors. When intruders enter the detection range of the infrared sensor, the sensor will output a signal to a control circuit board for processing and projection lights will be activated to achieve warning and deterrent effect.

The burglar alarm apparatus mentioned above usually has only one infrared sensor which can send out single detecting command to its receiver devices and perform one reaction. It has a limited detection scope. Many dead angles and directions cannot be detected. This gives thefts chances to invade the house or parking lot (garage). It becomes a serious security concern.

To remedy the aforesaid problem, some vendors have added an extra infrared sensor in the burglar alarm apparatus to form a double infrared sensors apparatus. Those two infrared sensors may detect different locations and directions. However, those two infrared sensors detect at the same time. Any one of them detects an intruder, the projection light will be turned on. If the intruder finds out that light inside the house or parking lot is still not being turned on, the intruder can use the projection light or the locations not covered by the two infrared sensors to invade the house and parking lot, and loss or damages might occur.

### SUMMARY OF THE INVENTION

Therefore the primary object of the invention is to resolve the aforesaid disadvantages and overcome the drawbacks of the prior art. The invention provides at least two detection units to detect at different time to achieve multiple detection and surveillance functions.

In order to achieve the aforesaid object, the multi-detection apparatus of the invention includes at least one control circuit board and at least two detection units. The control circuit board may receive signals output from the first and the second detection units at different time, and activate different devices at different time to achieve multiple detection and surveillance functions.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of an embodiment of the invention.

FIG. 2 is a circuit diagram of a control circuit board according to FIG. 1.

FIG. 3 is an illustrative view of another embodiment of the invention.

FIG. 4 is a sectional view according to FIG. 3.

FIG. 5 is a schematic diagram of yet another embodiment of the invention.

### DETAILED DESCRIPTION OF THE PREFERRED EMBODIMENTS

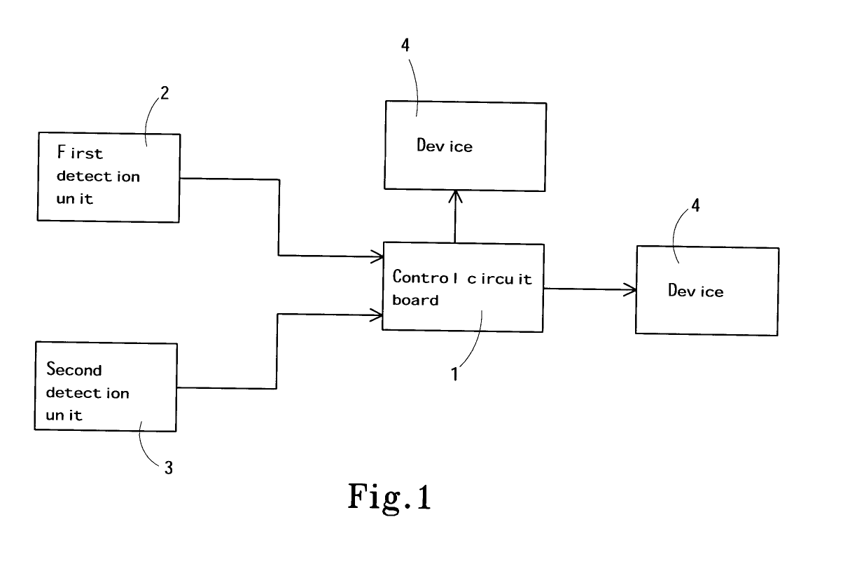

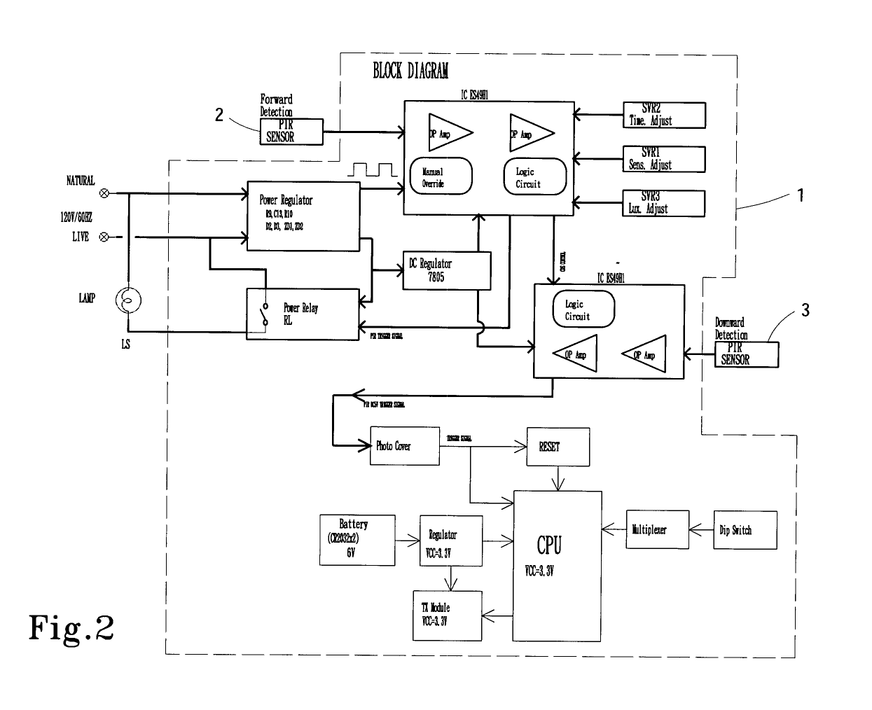

Referring to FIGS. 1 and 2, the multi-detection apparatus of the invention includes a control circuit board 1 and at least a first detection unit 2 and a second detection unit 3 connecting to the control circuit board 1. By equipping the first detection unit 2 and the second detection unit 3 in the detection apparatus, the two detection units 2 and 3 can detect at different time (asynchronously) to effectively scare off thefts from invading the house, company and parking lot or to simulate presence in one's property while he/she is away.

The first and the second detection units 2 and 3 may be infrared sensors, temperature sensors, or pressure (gravity) sensors. The first detection unit 2 and the second detection unit 3 may be directly installed in a shell or installed at different locations to detect at different time to achieve multiple detection and surveillance functions.

The control circuit board 1 is a technique known in the art, thus its technical details are omitted here. The control circuit board 1 is connected to an output end of the first detection unit 2 and the second detection unit 3. The signals detected by the first detection unit 2 and the second detection unit 3 at different time are delivered to the control circuit board 1 which processes the signals and drives different devices 4 at different time to achieve warning and scaring effect.

For instance, the devices 4 may be projection lights and household facilities (such as security systems, alarm devices, police stations, handsets, or the like). When a detection target (people, animal, vehicle) enters the detection range of the first detection unit 2 and is detected, the first detection unit 2 will output a signal to the control circuit board 1 which processes the signal and activates the projection light to expose the detection target and serve as the first warning. If the detection target is merely passing by the detection range of the first detection unit 2, it will not be detected by the second detection unit 3. If the detection target enters the detection range of the second detection unit 3, the second detection unit 3 will output a signal to the control circuit board 1 which processes the signal and turns on the light in the house (if no people is in the house at that moment). The intruder sees the light in the house being turned on abruptly mostly likely will think that there are people in the house and dares not invade. Thus warning and scaring effect may be accomplished.

Or the signals detected by the second detection unit 3 may be directly transmitted to the security system, alarm devices, police station, or user's handset to alert related people that an intruder is presenting so that they can rush to the site to take necessary measures.

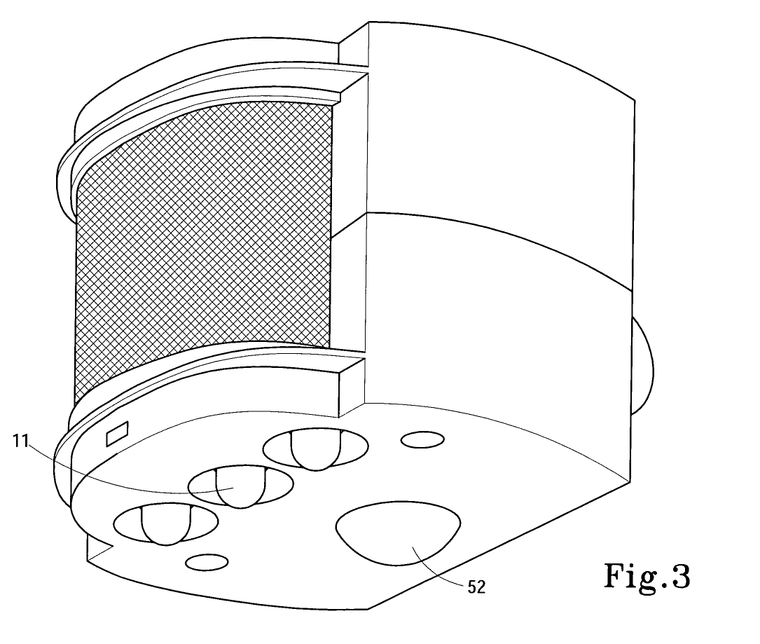

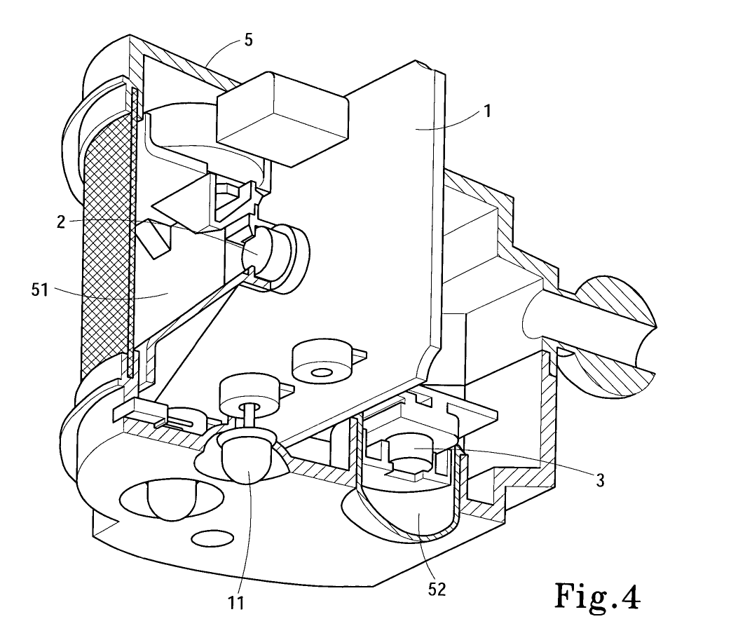

Refer to FIGS. 3 and 4 for another embodiment of the invention. In this embodiment the control circuit board 1, first detection unit 2 and second detection unit 3 are integrated in a shell 5. For instance, the first detection unit 2 and the second detection unit 3 may be installed on an upper side and a lower side of the shell 5. And detection windows 51 and 52 may be formed on the shell corresponding to the first and second detection units 2 and 3. The control circuit board 1 may be located between the first and the second detection units 2 and 3 to effectively receive the signals detected by the first and second detection units 2 and 3 and activate different devices 4 at different time. Moreover, a control switch 11 located on the control circuit board 1 may be extended outside the shell 5 to enable users to do various settings from outside of the shell 5.

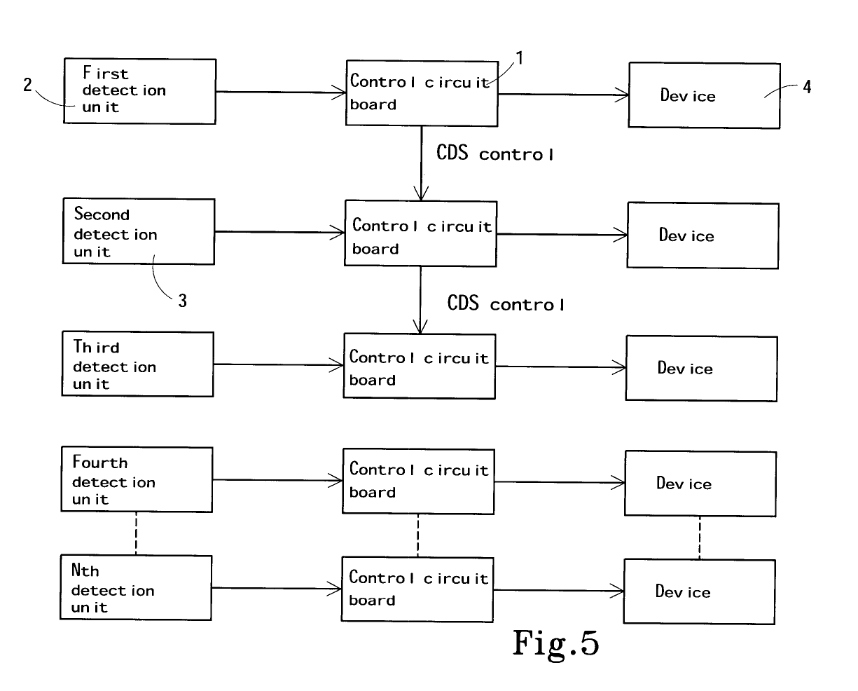

Referring to FIG. 5 for yet another embodiment of the invention. As shown in the drawing, the multi-detection apparatus of the invention may include multiple sets of detection units same as the first and the second detection units 2 and 3. And each detection unit is connected to a control circuit board 1. Then the detection units can detect signals at different time and transfer the signals to the control circuit board 1 for processing. And a single device 4 or many devices 4 may be activated at different time or at the same time to achieve multiple detection and surveillance functions.

Moreover, when the first and second detection units 2 and 3 are installed at different locations, such as the first detection unit 2 is installed outdoors and is an infrared sensor, and the second detection unit 3 is installed in a stairway or a hallway, and is a temperature sensor or pressure sensor.

Furthermore, if the first and second detection units 2 and 3 are installed outdoors, the control circuit board 1 aside from activating different devices 4 in a wired manner, may also include an emission unit. And the devices 4 may include a receiving unit. So that after the control circuit board 1 has processed the signals detected by the first and second detection units 2 and 3, it can activate the devices 4 in a wireless manner to achieve remote control.

1. A multi-detection apparatus installed at a surveillance location to activate different devices at different time, comprising:
at least one control circuit board; and
at least two detection units which have respectively an output end connecting to input ends of the control circuit board;
wherein when the detection units detect a detecting target at different time, the control circuit board receives signals at different time output from the detection units and activates the different devices at different time to achieve multiple detection and surveillance functions.

2. The multi-detection apparatus of claim 1, wherein the detection units are selectively infrared sensors, temperature sensors or pressure (gravity) sensors.

3. The multi-detection apparatus of claim 1, wherein the detection units are installed in a shell.

4. The multi-detection apparatus of claim 1, wherein the detection units are installed at different locations including outdoors and a stairway or a hallway.

5. The multi-detection apparatus of claim 1, wherein the control circuit board activates the devices in a wired or a wireless fashion.

6. The multi-detection apparatus of claim 5, wherein the wireless fashion includes an emission unit installed on the control circuit board and a receiving unit installed in the each of the devices.

7. The multi-detection apparatus of claim 1, wherein the devices are selectively projection lights, household facilities, security systems, alarm devices, police stations, or handsets.
